(19) United States
(12) Patent Application Publication
(10) Pub. No.: US 2025/0052931 A1
(43) Pub. Date: Feb. 13, 2025

(54) Optical Device With Stray Light Reduction

(71) Applicant: Pilz GmbH & Co. KG, Ostfildern (DE)

(72) Inventors: Daniel Ambuehl, Bad Ragaz (CH); Dominik Guldimann, Bad Ragaz (CH); Zuzanna Konieczna, Bad Ragaz (CH); Sergiy Mayilo, Bad Ragaz (CH); Joel Ritter, Bad Ragaz (CH); Martin Wendler, Ostfildern (DE)

(21) Appl. No.: 18/800,100

(22) Filed: Aug. 11, 2024

(30) Foreign Application Priority Data
Aug. 11, 2023 (DE) 102023121625.2

(51) Int. Cl. G02B 5/00; G02B 3/08

(52) U.S. Cl. CPC G02B 5/003; G02B 3/08

(57) ABSTRACT

An optical device includes a beam-forming element made of a first material with a base surface and a top surface, which are opposite one another, and with a surrounding lateral surface, which connects the base surface and the top surface to one another. The optical device includes a support body made of a second material, which is formed with a receptacle for the beam-forming element and has at least one common contact surface with the lateral surface. The first material and the second material are in direct contact with each other. The first material is permeable to, and the second material is absorbent to, a defined electromagnetic radiation. A defined refractive index (n₂) of the second material is set in a defined ratio to a defined refractive index (n₁) of the first material in order to set a specific transition characteristic for the defined electromagnetic radiation at the contact surface.

### CROSS-REFERENCE TO RELATED APPLICATIONS

This application claims priority to German Application No. 10 2023 121 625.2 filed Aug. 11, 2023. The entire disclosure of the application referenced above is incorporated by reference.

### FIELD

The present disclosure relates to an optical device, such as a safety light barrier, safety light grid, or safety laser scanner, and to a corresponding method for manufacturing such a device.

### BACKGROUND

In general, an optical device is a technical device that uses electromagnetic radiation, especially light, to capture, process, manipulate or display information. Optical devices are used in many areas, e.g. photography, astronomy, microscopy, ophthalmology, communication, consumer electronics and many others. Optical devices use the properties of light such as reflection, refraction and absorption. They use lenses, mirrors, prisms and other optical components to direct and shape light. Examples of optical devices include cameras, binoculars, microscopes, telescopes, lasers, projectors, screens and optical sensors.

Optical sensors are devices that use light to measure or detect certain physical or chemical properties. They convert optical signals into electrical signals, which can then be analyzed and interpreted. Optical sensors are used in many areas, e.g. in industry, medicine, environmental monitoring, safety technology and automation. Examples of optical sensors include light barriers including light grids or laser scanners. Light barriers have one or more light sources (transmitters) and one or more light receivers. If the light between the transmitter and receiver is interrupted, for example by an object or a person, the sensor detects the change and emits a signal. Light barriers and light grids are frequently used in automation technology, for access control and on machines as electro-sensitive protective equipment (ESPE).

Various standards and safety regulations must be observed when using ESPEs, such as light grids, on technical systems. For Europe, these include EN ISO 13849-1, EN 61496-1 and EN 61496-2 as well as EN 62046.

EN ISO 13849-1 deals with the safety of machinery and defines requirements for safety-related control systems, including the use of light curtains as protective devices. EN 61496-1 and EN 61496-2 describe the general requirements and test methods for light curtains and light barriers, including their electrical and optical properties. EN 62046 deals with the use of light curtains for machine control and describes requirements for the function, installation, commissioning, operation and maintenance of light curtains.

For ESPE, these standards specify, among other things, limiting the permissible aperture angle for transmitters and receivers, i.e. in particular limiting and minimizing the influence of stray light on the system. An important source of this scattered light is the reflection and scattering of light on the walls of a housing defining the optical channel, e.g. a tube. Light traps are a well-known method of dealing with stray light. They prevent a light beam from being reflected or scattered by the walls and reaching a detector.

As an example of such a light trap, EP 1 420 271 A2 shows an element holder as a one-piece element with a light-blocking component to limit the scattering angle of the light. The element holder has a cylindrical inner channel and can detachably hold an optical element at one end. A lens is attached to one opposite end of the element holder. The element holder is a molded plastic member and has a single light-shielding wall integrally molded with the element holder so that it extends across the inner channel in a plane approximately equidistant from the optoelectronic detector element and the lens to limit the angle of light scattering.

DE 199 10 321 A1 shows another example of the use of light traps in a light barrier or light grid.

Another way to deal with stray light is to use special filters or adapted light sources. An example of this is shown in EP 2 535 741 A2. Here, phosphor-based layers comprising, for example, a mixture of nano-phosphorus and/or quantum dot phosphor are used to filter received light (including both intended reflected light and sunlight) prior to reception by a light detector SUMMARY

It is an object to provide a new, cost-effective method for minimizing stray light. Another object is to specify a manufacturing method for an optical device that efficiently implements the new cost-effective method for minimizing stray light.

According to one aspect of the present disclosure, this problem is solved by an optical device comprising: a beam-forming element of a first material having a base surface and a top surface opposite each other and a surrounding lateral surface connecting the base surface and the top surface; a support body (carrier) of a second material formed with a receptacle (holder) for the beam-forming element and having at least one common contact surface with the lateral surface of the beam-forming element. The first material and the second material are in direct contact with each other at the contact surface between the beam-forming element and the support body. The first material is permeable to a defined electromagnetic radiation and the second material is absorbent to the defined electromagnetic radiation. Furthermore, the first material and the second material each have a defined refractive index (n₁, n₂) in relation to the defined electromagnetic radiation. The defined refractive index of the second material is set in a defined ratio to the defined refractive index of the first material in order to set a specific transition characteristic for the defined electromagnetic radiation at the contact surface.

According to a further aspect of the present disclosure, this problem is further solved by a manufacturing method for an optical device comprising a beam-forming element and a support body. The method, comprising: providing a first material for the beam-forming element which is permeable to a defined electromagnetic radiation and has a first defined refractive index relative to the defined electromagnetic radiation; providing a second material for the support body which is absorbent to the defined electromagnetic radiation and has a second defined refractive index relative to the defined electromagnetic radiation; forming the beam-forming element from the first material and the support body from the second material; joining the first material and the second material to form an integrally joined (one-piece and therefore non-destructively separable) component from the first material and the second material, wherein the beam-forming element has a base surface and a top surface which are opposite one another, and a surrounding lateral surface which joins the base surface and the top surface to one another, wherein the support body is formed with a receptacle for the beam-forming element and has at least one common contact surface with the surrounding lateral surface of the beam-forming element, and wherein the defined refractive index of the second material is set in a defined ratio to the defined refractive index of the first material in order to set a specific transition characteristic for the defined electromagnetic radiation at the contact surface.

It is therefore an idea to counter the undesirable effects of stray light, which can influence the optical device, by selecting the material for the beam-forming element and its support body and joining them together. For this purpose, at least one contact surface between the beam-forming element and the support body, at which reflection or refraction of light is to be avoided or at least reduced, must be set up in such a way that the material of the beam-forming element and that of the support body are in direct contact with each other at the contact surface. Preferably, the beam-forming element and the support body are joined together during assembling in such a way that the contact surface is free of cavities and, in particular, no gaseous medium is trapped between the first and second materials. Preferably, the first material and the second material therefore lie directly and flatly against each other at the contact surface, without a third material, which differs from the first material and the second material, being arranged between them. In some preferred embodiments, the first and second materials are integrally joined together in an injection molding process. For example, the first material can be molded onto the second material or vice versa. In other preferred embodiments, the first material and the second material can be thermally welded together, in particular by laser welding. In principle, it is also conceivable to join the first material and the second material by dissolving with a volatile adhesive or by blasting directly and without an intermediate layer of a different material to form an integral component. The beam-forming element, for example a lens, is made of a material that is permeable to the defined electromagnetic radiation, in particular in the wavelength range of visible and/or infrared light. For its part, the support body is made of a material that absorbs electromagnetic radiation in the wavelength range, at least on a part located behind the contact surface. Furthermore, the refractive indices for the material of the beam-forming element and the support body are selected in relation to the electromagnetic radiation in such a way that a certain transition characteristic is achieved at the contact surface. In particular, the refractive indices are selected such that the electromagnetic radiation can enter the second material at the at least one contact surface as reflection-free as possible and is subsequently absorbed by the second material as far as possible, i.e. in particular that the contact surface is largely low-reflection and low-refraction due to the material pairing.

It has been shown that the refractive indices of the material of the beam-forming element and the material of the support body should be aligned. The ratio between the refractive indices is preferably 1. It follows from the Fresnel formula that with essentially the same refractive indices in a certain angle of incidence range, incident light enters the support body material largely unreflected and unrefracted and can be absorbed by it. Light that strikes the contact surface from this angle of incidence can thus be prevented from propagating further through the beam-forming element in a simple and effective way. The detection of incident light or the emission of light beams can be advantageously controlled in this way, as scattered light effects can be effectively avoided or reduced. Preferably, the material for the beam-forming element and the material for the support body are the same material with different absorption coefficients, i.e. the first material and the second material are based on the same base material. The material can be processed into the support body and the beam-forming element in a joint forming process.

Since the scattered light reduction is essentially set via the material of the support body and the beam-forming element and its processing, the structure of the beam-forming element and the support body can essentially be freely selected. This opens up new possibilities for making optical devices simpler and more effective, as well as faster and cheaper to manufacture.

In a further refinement, the defined ratio of the refractive indices of the support body material and the material of the beam-forming element can be between 0.9 and 1.1, preferably between 0.95 and 1.05, in particular 1.

In this arrangement, the refractive indices of the different materials for the beam-forming element and the support body are preferably the same or at least very similar in order to achieve the desired transition characteristics. This can be achieved easily by using the same base material for both components, whereby the base material is made radiation-absorbent for the support body, e.g. by adding pigments.

In a further refinement, the specific transition characteristic can cause the contact surface to be low-reflection and low-refraction for the defined electromagnetic radiation coupled in through the base surface and top surface. In various embodiments the specific transition characteristic can cause the contact surface to be reflection-free and refraction-free.

Furthermore, in a further refinement, the specific transition characteristic can cause the defined electromagnetic radiation coupled in by the base surface and the top surface in a defined angle of incidence range to be absorbed by the second material.

The transition characteristic, which can be adjusted by the choice of material, thus enables the contact surface to be adapted to the required conditions, which may be specified by the structure of the beam-forming element and/or the support body, the type of electromagnetic radiation or the type of coupling of the electromagnetic radiation into the beam-forming element. The optical device can be designed particularly flexibly in this way.

In a further refinement, the first material can be a transparent plastic and the second material a pigmented or colored plastic. The second material can be a black-colored plastic.

Plastics can easily be molded into different shapes. The properties of plastics can also be influenced by the addition of various foreign substances. Specifically, this relates to the optical properties. Furthermore, plastics can be processed well in injection molding processes. For example, different plastics can be processed simultaneously in an injection molding process and joined together to form a one-piece component so that a direct, jointless connection is created between the individual plastics. Black plastic is particularly light-absorbing. The use of plastic as a base material therefore advantageously simplifies the construction of the optical device described above.

In further refinement, the plastic used for the first and/or second material may include or consist of polycarbonate (PC), polymethyl methacrylate (PMMA), cycloolefin copolymers, optical polyesters or polysulfones. PMMA or polymethyl methacrylate is also known as acrylic glass or Plexiglas. PMMA is a transparent thermoplastic polymer formed from methyl methacrylate monomer units and is characterized by high light transmission and optical clarity. It is almost colorless to the human eye and has a similar transparency to glass, but with a lower weight. The use of PMMA as a base material therefore favors the optical properties of the optical device. Polycarbonate is preferred in some embodiments due to its good mechanical properties, such as elongation at break and impact strength. A polycarbonate substrate allows connection options such as snap-on hooks or cold embossing points, which would be difficult to realize with PMMA.

The beam-forming element and the support body can be designed as a one-piece, i.e. integrally jointed component, and formed by a multi-component injection molding process, for example a cascade injection molding process or a sandwich injection molding process.

A one-piece component integrally jointed from at least two components simplifies the assembly of the optical device and allows it to be manufactured cost-effectively. A multi-component injection molding process enables a seamless connection between the materials used in a proven and automated manufacturing process in a very efficient way. This ensures that the effects of the material selection described above (adjustment of the refractive indices) occur at the contact surface, as no other medium is trapped between the materials. In addition, injection molding generally allows for very flexible shaping. In principle, however, the one-piece component can also be manufactured in another way, for example using a laser welding process with which the beam-forming element and the support body are integrally joined to form the one-piece component

In a further refinement, the receptacle is funnel-shaped and tapered in a direction from the top surface to the base surface.

According to this design, the receptacle can be funnel-shaped, which allows the beam-forming element to be advantageously reduced in size. The funnel-shaped design, which is generally rather unsuitable for reducing scattered light, can nevertheless be used here thanks to the special choice of material in such a way that the aforementioned reduction in size is achieved. Reducing the size of the beam-forming element helps to save material and minimizes the likelihood of blowholes forming in the element body, as the overall volume of the beam-forming element becomes smaller. This arrangement thus further contributes to a cost-effective and optimized design of the optical device.

In a further refinement, the receptacle can enclose at least part of the base surface with at least one opening for the defined electromagnetic radiation, the opening being designed as an aperture for an optoelectronic element in the beam path, e.g. an optoelectronic emitter or detector. In a further refinement, which can be implemented alternatively or additionally, the receptacle forms a tube protruding from the top surface.

According to this design, further elements and production steps can be omitted by realizing one or more optical apertures in the beam path of the optical device directly through the support body. In some preferred embodiments, the support body forms an aperture diaphragm in the beam path. Furthermore, the support body can form an aperture that defines the resolution of a light grid with a large number of light beams running parallel to each other. In a particularly preferred embodiment, the beam-forming element and the receptacle form a one-piece component that implements an optical lens and a tube with a resolution-defining aperture. All these variants contribute to further cost savings in the manufacture of the optical device, particularly in the form of a safety light barrier or a safety light grid.

The aperture can be filled with the material of the beam-forming element.

This design facilitates joining of the support body and the beam-forming element into a one-piece component and simplifies its manufacture. This refinement can therefore also contribute to further cost savings. A further advantage of this design is that the lens axis and pinhole axis (tube) lie very precisely on top of each other due to the two component (2K) injection molding manufacturing process, and that the deviation from the ideal optical axis can be kept very small. This improves the availability and alignability of a light grid.

In a further refinement, protruding structures are formed in the receptacle which act as light traps.

For example, the structures can include staircase-like steps, crenellated projections and/or a large number of high, comb-like walls. As explained at the beginning, light traps are already known as such. However, the embodiment can be combined particularly advantageously with the specific transition characteristic at the contact surface between the first and the second material, because the advantageous effects of the specific transition characteristic are particularly effective at smaller angles of incidence of the defined electromagnetic radiation, whereas light traps are particularly effective at larger angles of incidence.

In a further refinement, the optical device has a large number of beam-forming elements, each of which has its own receptacle in the support body.

In this refinement, a plurality of beam-forming elements can be formed simultaneously with the support body, which advantageously simplifies the manufacture of special optical devices, such as light grids with a plurality of optical elements.

In a further refinement, the optical device is an optical sensor, in particular a safety light grid or a laser scanner, which fulfills the safety requirement level SIL 3 according to IEC 61508/IEC61511 or a performance level PL d according to EN ISO 13849-1.

As already mentioned, optical sensors are devices that use light to measure or detect certain physical or chemical properties. They convert optical signals into electrical signals, which can then be analyzed and interpreted. With optical sensors, it is particularly important that only dedicated light triggers a detection and that unwanted stray light, which can lead to false triggering or—even worse—prevent the detection of a safety-relevant object, is avoided. This can be advantageously achieved by the designs described above, so that optimized optical sensors can be realized.

In a further refinement, the optical device can be a light grid.

Light grids have many optical elements that work together to create an electro-sensitive protective equipment (ESPE), i.e. a non-contact protective device, for example. Since many optical elements corresponding to the configuration shown above can be realized in a simple manner, a light grid can be implemented in this way in a particularly cost-effective manner.

It is understood that the above-mentioned features and those to be explained below can be used not only in the combination indicated in each case, but also in other combinations or on their own, without departing from the scope of the present invention

### BRIEF DESCRIPTION OF THE DRAWINGS

Embodiments of the invention are shown in the drawings and are explained in more detail in the following description.

FIG. 1 shows a schematic cross-sectional view of an optical device with a light trap for minimizing stray light, which corresponds to the state of the art.

FIG. 2 shows a schematic cross-sectional view of an optical device according to an embodiment of the present disclosure with a passive optoelectronic element.

FIG. 3 shows a schematic cross-sectional view of the optical device according to the embodiment of FIG. 2 with an active optoelectronic element.

FIG. 4A shows a schematic cross-sectional view of a further variant of the embodiment according to FIG. 2 in a plan view.

FIG. 4B shows a schematic cross-sectional view of a further variant of the embodiment according to FIG. 2 in a sectional view.

FIG. 4C shows a schematic cross-sectional view of a further variant of the embodiment according to FIG. 2 in a sectional view.

FIG. 5 shows a schematic cross-sectional view of a further variant of the embodiment according to FIG. 2 in a sectional view.

FIG. 6A shows a schematic cross-sectional view of a further variant of the embodiment according to FIG. 2 in a sectional view.

FIG. 6B shows a schematic cross-sectional view of a further variant of the embodiment according to FIG. 2 in a sectional view.

FIG. 7A shows an application example of an optical device of the present disclosure in a perspective view.

FIG. 7B shows a plan view of the application example shown in FIG. 7A.

FIG. 7C shows a side view of the application example shown in FIG. 7A.

FIG. 7D shows the application example according to FIG. 7A in a cross-sectional view along line C-C′ in FIG. 7C.

FIGS. 8A-8C show variants with additional light traps inside the support body. is a schematic representation of an apparatus for carrying out a safety function according to an exemplary embodiment.

### DETAILED DESCRIPTION

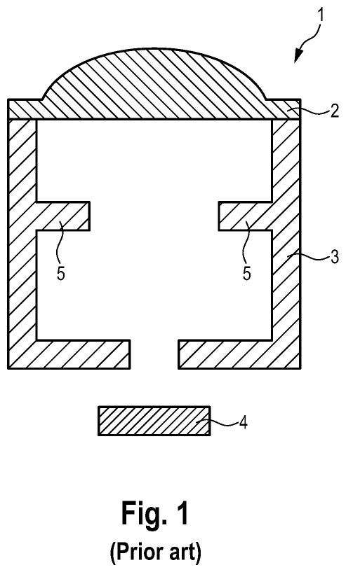

FIG. 1 shows an optical device 1 with a light trap for minimizing stray light, which corresponds to the state of the art.

In the embodiment shown, the optical device 1 from the prior art consists of three individual parts, namely a beam-forming element (lens) 2, a support body 3 in the form of a tube and an optoelectronic element 4. Electromagnetic radiation, in particular light, is coupled into the optical device via the beam-forming element 2. The tube-like support body 3 forms an optical channel through which the coupled light is guided to the optoelectronic element 4. Light traps are formed inside the tubular support body 3, which prevent some of the incident light, in particular the light reflected from the walls of the tube, from reaching the optoelectronic element 4. The light traps 5 reduce the influence of stray light on the detection by the optoelectronic element 4.

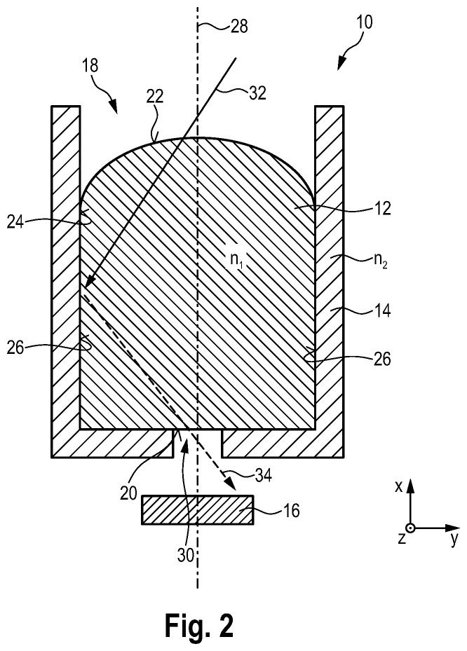

FIG. 2 shows an optical device according to an embodiment of the present disclosure.

The optical device as a whole is designated here the reference numeral 10. Like the optical device from the prior art, the optical device 10 also has a beam-forming element 12 and a corresponding support body 14. In addition, an optoelectronic element 16 can be provided, which in this example is designed as a detector for electromagnetic radiation, in particular light. In other embodiments, the optoelectronic element may include a transmitter for electromagnetic radiation, in particular light in the visible and/or infrared range. Such a transmitter is referred to below as an active element, a detector as a passive optoelectronic element.

The support body 14 is designed as a receptacle 18 or has at least one such receptacle, into which the beam-forming element 12 is mounted. The beam-forming element 12 has a base surface 20, a top surface 22 opposite the base surface and a lateral surface 24 connecting the base surface and the top surface. The beam-forming element 12 can be a homogeneous body with a uniform composition and structure, i.e. the material properties such as density, chemical composition and physical properties can be the same in every part of the body.

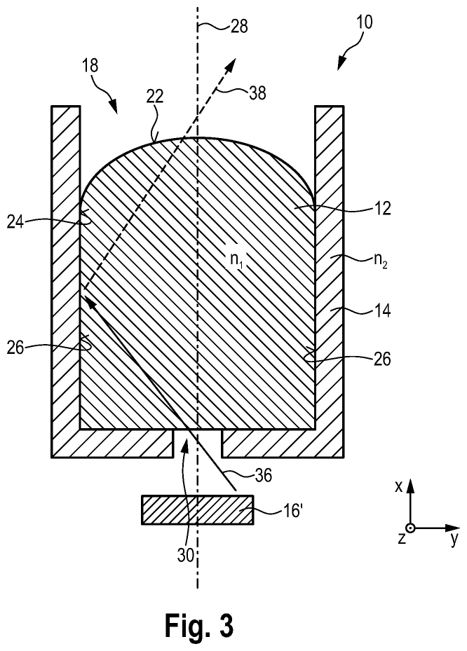

As shown here, the receptacle 18 for the beam-forming element 12 can be designed as a tube, the free end of which protrudes beyond the top surface 22 and thus forms an aperture. In a light barrier, light grid or laser scanner, this aperture can define the resolution with which the optical device can detect objects. However, the form of the receptacle 18 is not limited to this. The beam-forming element 12 received in the receptacle 18 has at least one common contact surface 26 with the support body 14. Here, the contact surface 26 is a section of the lateral surface 24. In various embodiments, the contact surface 26 can also comprise the entire lateral surface 24 and portions of the base surface 20. The top surface 22 or at least a part thereof is exposed from the support body 14. Electromagnetic radiation can be coupled into the optical device 10 from the outside via the top surface 22 (FIG. 2) or electromagnetic radiation can be emitted from the optical device 10 via the top surface 22 (see FIG. 3).

In the example shown, an optical axis 28 of the optical device 10 extends along a first direction (hereinafter referred to as the x-direction). The base surface 20 and the top surfaces 22 of the beam-forming element 12 are transverse, in particular perpendicular to the x-direction. The lateral surface 24 can in turn be a surface of rotation about the optical axis 28 or a surface consisting of a plurality of lateral surfaces which together connect the base surface 20 and the top surface 22. In the example shown, the lateral surface has a first side surface and a second side surface which run transversely, e.g. vertically, in a second direction perpendicular to the first direction (referred to below as the y-direction). The first side surface and the second side surface are here part of the contact surface 26 with the support body 14. The top surface 22 can be free of the support body 14 in the x-direction. Electromagnetic radiation is coupled into the optical device 10 from outside or emitted via the top surface 22. The base surface 20 is opposite the top surface 22 and is at least partially covered by the support body 14. An opening (aperture) 30 can be provided in the base surface 20, through which the electromagnetic radiation can be emitted to the optoelectronic element 16 or through which the optoelectronic element 16 can couple radiation into the beam-forming element 12. The opening 30 can also perform other optical functions, for example as an aperture diaphragm. In a third direction, which runs both perpendicular to the first direction and perpendicular to the second direction (hereinafter referred to as the z-direction), the beam-forming element 12 can also be surrounded by the support body 14, so that these portions can also be part of the contact surface 26.

The material (first material) from which the beam-forming element 12 is formed and the material (second material) from which the support body 14 is formed are selected or prepared in a particular manner in order to achieve a defined transition characteristic of the electromagnetic radiation propagating through the beam-forming element 12 at the contact surface 26. Accordingly, the first material is a material that is permeable to electromagnetic radiation, preferably colorless, with a transparency similar to that of glass. The second material, on the other hand, is an opaque material that absorbs electromagnetic radiation. The degree of absorption of the second material for electromagnetic radiation is as high as possible. The second material is therefore preferably black.

The beam-forming element 12 is integrated into the receptacle 18 in such a way that the first material lies seamlessly against the second material at least on the one common contact surface 26. The transition characteristic at the contact surface 26 is essentially determined by the refractive indices (n₁, n₂) of the first material and the second material according to the Fresnel formula. In order to achieve the lowest possible reflection and refraction transition characteristics at the contact surface, the refractive indices (n₁, n₂) of the first and second materials are the same or at least similar within a narrow tolerance range (e.g. less than 5%) (n₁≈n₂). In this case, the rays impinging on the contact surface 26 (at least rays in a defined angle of incidence range) are not refracted or reflected at the contact surface, or only to a small extent, but pass almost completely into the second material of the support body 14 and are absorbed there.

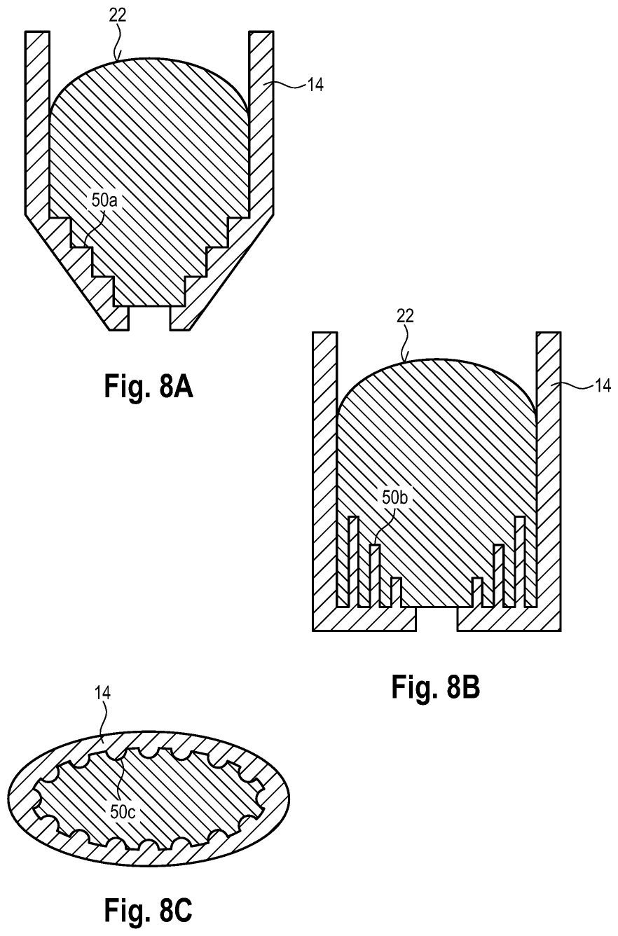

Unwanted scattered light, which is coupled into the beam-forming element 12 through the top surface 22 at an angle to the optical axis 28, here exemplified by the arrow 32, is not reflected at the contact surface 26 onto the optoelectronic element 16, as is usually the case and here indicated by the arrow 34, but is absorbed by the material of the support body 14. This prevents unwanted scattered light from reaching the optoelectronic element 16 and causing false detection. The optical device according to FIG. 2 can therefore be realized in some embodiments without the light traps shown in FIG. 1 or the filters mentioned in the introduction to the description. However, in other embodiments, the optical device may have additional structures inside the receptacle 18 that act as a light trap. The structures can be, for example, stair-like steps that are formed in a funnel-shaped section tapering in the direction of the base surface 20 (FIG. 8A), concentric walls (FIG. 8B) that rise from the base surface 20 like a comb in cross-section, or crenellated projections on the inner wall of the receptacle 18 (FIG. 8C). The minimization of scattered light can thus be achieved solely by the suitable choice of material and the jointless arrangement of the beam-forming element 12 in the receptacle 18 of the support body 14 or in addition to light traps.

To achieve the specific material selection and the required seamless arrangement of the beam-forming element 12 in the support body 14, the optical device 10 can be advantageously realized by injection moulding. Injection molding makes it possible to join two materials, especially plastics, in such a way that the joint is seamless and generally inseparable. Injection molding, in which at least two materials are combined to form a one-piece component, is also known as two-component (2K) or multi-component injection molding. There are various two-component injection molding processes that can be used. These include cascade injection molding and sandwich injection molding. In cascade injection molding, a first component is injected into the injection mold and then a second component is injected onto the first component. The mold is usually designed so that the second component flows into the cavities of the first component and forms a solid bond. In sandwich injection molding, two components are injected into the mold at the same time, with one component enclosing the other.

The beam-forming element 12 can be one component and the support body 14 the other component. It does not matter which component is the first component and which is the second component. Depending on the desired application and the required structure of the optical device 10, either the beam-forming element 12 can be injected onto the support body 14 during injection molding or vice versa. Preferably, the beam-forming element 12 (lens) is injected first and then the enveloping tube 14, because in this case the tube shrinks onto the lens during cooling.

In addition, the material selection required to achieve the desired effect is also facilitated by the use of an injection molding process, as a multi-component injection molding process is generally designed for the use of different materials. The starting material for the beam-forming element 12 and the support body 14 is preferably the same material, in particular a plastic such as polycarbonate or PMMA. In order to adjust the required absorption capacity of the second material, the common starting material for the support body 14 can be provided with pigments in order to achieve a high degree of absorption for electromagnetic radiation. While the modification achieves a high degree of absorption, the refractive index remains unchanged by this modification of the starting material, so that the first material and the second material have an essentially identical refractive index. The starting material (first material) and the modified starting material (second material) can then be injection molded in a manner known per se to form a one-piece component with the structure and material properties described above.

The use of a common base material also has the advantage that temperature influences act evenly on both components and thus stresses between the individual components, in this case the beam-forming element 12 and the support body 14, can be advantageously avoided.

FIG. 3 shows the optical device according to the embodiment of FIG. 2 with an active optoelectronic element 16′.

The optical device 10 according to FIG. 3 corresponds to the optical device 10 according to FIG. 2 with regard to the beam-forming element 22 and the support body 14. The embodiments differ here only with regard to the optoelectronic element 16′, which is an active element in the present embodiment. The active element 16′ is designed to emit electromagnetic radiation and to couple it into the beam-forming element 12, whereby a large part of the radiation coupled in by the optoelectronic element 16′ propagates through the beam-forming element 12 and is radiated outwards via the top surface 22. However, some of the radiation may also impinge on the contact surface 26 between the beam-forming element 22 and the support body 14, as shown by the light beam 36. This radiation is also absorbed as completely as possible by the support body 14 in accordance with the special design of the support body 14 and the beam-forming element 12, so that no or only slight reflection, as indicated here by the beam 38, takes place.

Advantageously, the structure described can thus also improve the radiation characteristics of the optical device 10. It is understood that the designs shown in FIG. 2 and FIG. 3 can also be combined. For example, a so-called transceiver light grid has a large number of optoelectronic elements on each side of the light grid, which alternately contain a transmitter or a receiver.

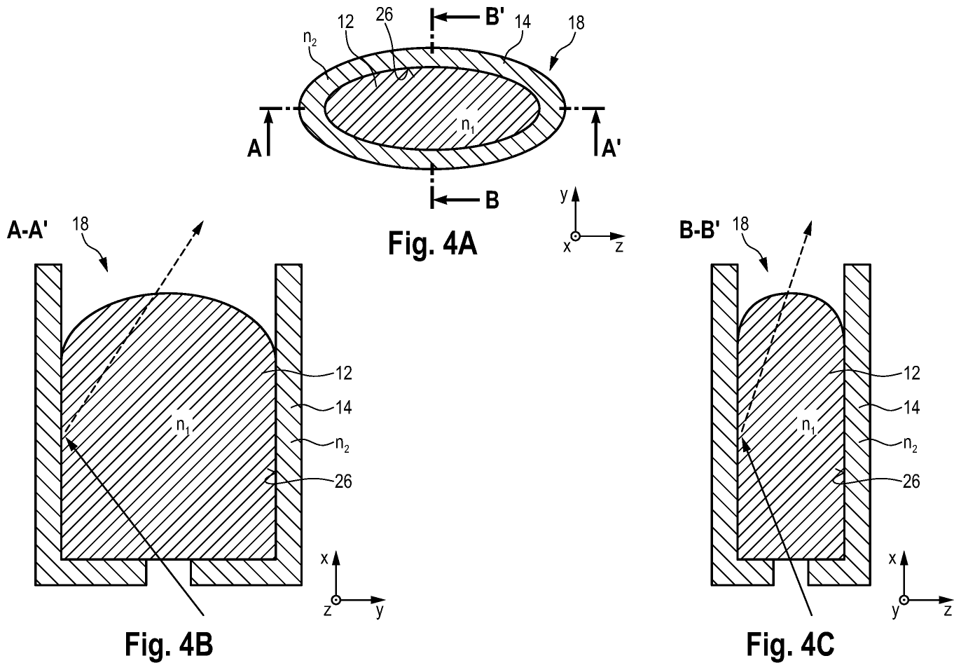

FIGS. 4A, 4B and 4C each show a schematic representation of a further variant of the embodiment according to FIG. 2 from different perspectives.

FIG. 4A shows a plan view in the x-direction, FIGS. 4B and 4C each show a sectional view in the z-direction and in the y-direction, as can be seen from the reference systems and the sectional lines shown. The same reference signs denote the same parts as in FIG. 2.

In this embodiment, the beam-forming element and the receptacle 18 of the support body 14 are oval in cross-section, i.e. the beam-forming element 12 has a smaller dimension in the y-direction than in the z-direction. In this view, the receptacle 18 of the support body 14 surrounds the beam-forming element in the shape of a ring. The wall thickness of the receptacle 18 is small in relation to the width and length of the beam-forming element 12. Depending on the application or manufacturing process, the wall thickness can be homogeneous or inhomogeneous, in particular with structures that act as light traps (see FIG. 8C). The design of the optical device shown in FIGS. 4A, 4B and 4C is advantageous because the shape is thin due to the reduced wall thickness and therefore favorable for the injection molding process.

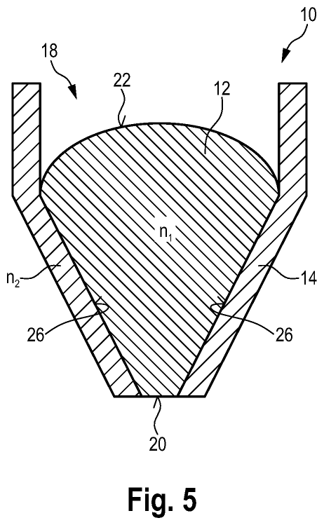

FIG. 5 shows a cross-sectional view of a further variant of the embodiment according to FIG. 2 in a side view.

In contrast to the previous embodiments, in the present embodiment according to FIG. 5, the receptacle 18 of the support body 14 is funnel-shaped. An opening width of the top surface 22 of the beam-forming element 12 is therefore greater than an opening width of the receptacle 18 on the side of the base surface 20. A funnel-shaped design is generally undesirable in prior art devices, since in this shape light can be reflected and scattered towards the optoelectronic element at the inner surfaces of the receptacle 18. However, due to the form of the beam-forming element 12 and the support body 14, i.e. the choice of material and the joining thereof, in this case there is little or no scattering or reflection at the contact surfaces 26, so that the advantages described are particularly effective.

In many cases, a funnel-shaped design facilitates the removal of an injection-molded part from an injection mold and can therefore be desirable. In addition, the funnel-shaped design has the advantage that the volume of the beam-forming element 12 can be reduced and thus the occurrence of blowholes can be advantageously reduced. In addition, the less material for the beam-forming element 12 is required due to the smaller volume.

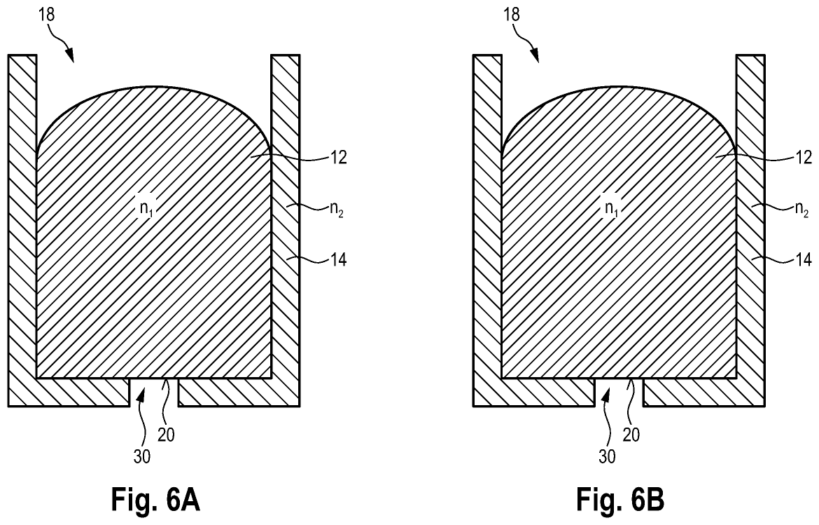

FIGS. 6A and 6B show a cross-sectional view of two further variants of the embodiment according to FIG. 2 in a side view.

As already described for FIGS. 2 and 3, the receptacle 18 of the support body 14 can have an opening 30 on the base surface 20, which serves, for example, as an optical diaphragm. The opening 30 can be formed in different ways. On the one hand, the opening 30 can be left open as shown in FIG. 6A, while in FIG. 6B the opening 30 is filled with the material (first material) of the beam-forming element 12. Both variants can be advantageous depending on the application or manufacturing process and are equally feasible in the injection molding process. However, the latter variant is particularly suitable for the injection molding process in order to achieve a good joint between the support body 14 and the beam-forming element 12.

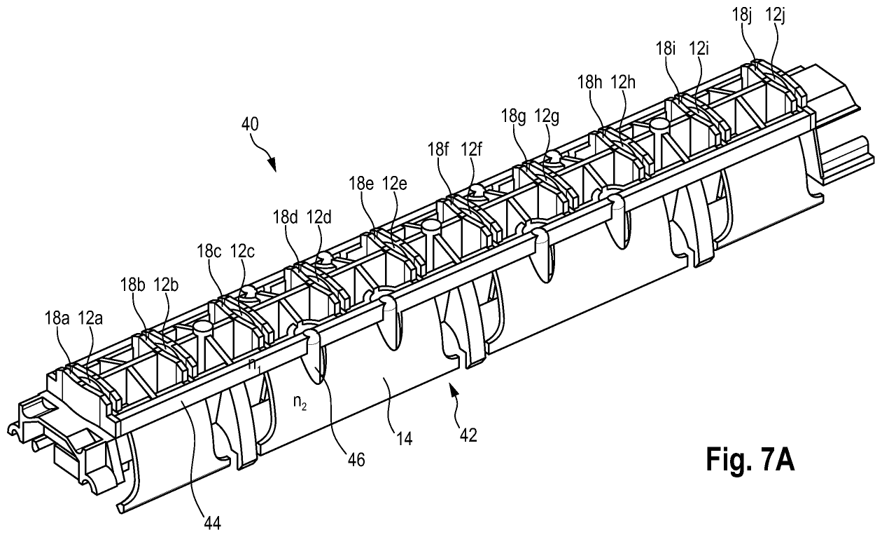

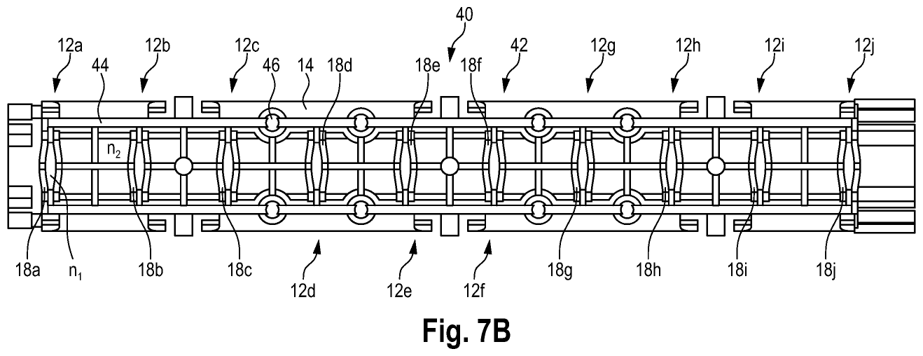

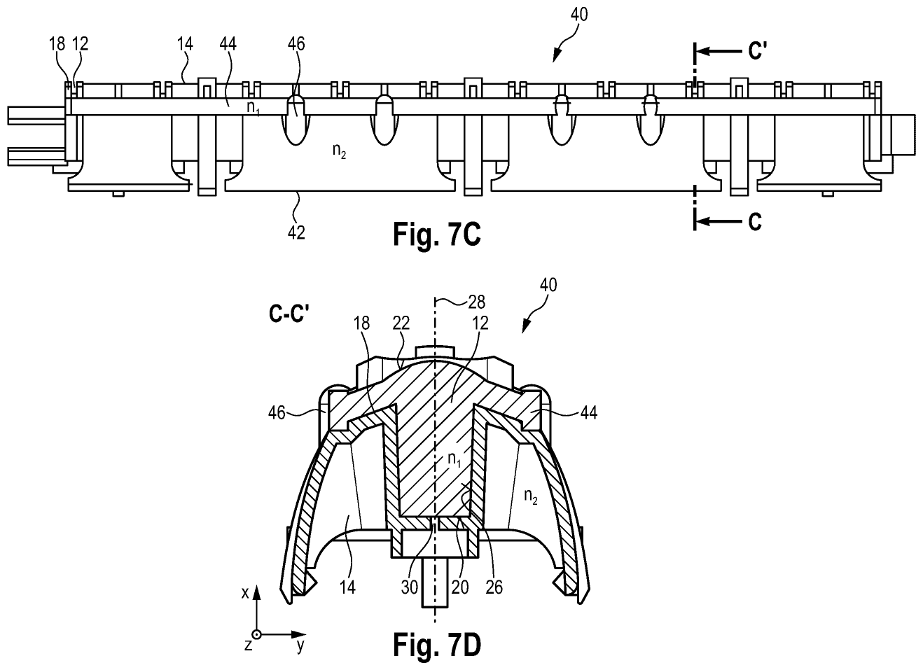

FIG. 7A shows an application example of an optical device of the present disclosure in a perspective view. FIG. 7B shows the application example according to FIG. 7A in a plan view, FIG. 7C in a side view and FIG. 7D in a cross-sectional view along line C-C′ from FIG. 7C.

The application example relates to a light grid 40, the base body 42 of which is shown in FIG. 7A to 7D. The base body 42 is a one-piece component that is formed from two components by injection molding. The first component is the support body 14 and the second component is the beam-forming element 12. More precisely, the second component here has ten beam-forming elements 12a to 12j, each of which is mounted in a corresponding receptacle 18a to 18i of the support body 14. As described above, the support body material (second material) and the material of the beam-forming element 12 (first material) are selected in such a way that reflections and refractions in the receptacle 18 are avoided or reduced.

In addition to the receptacles 18a to 18j, the support body 14 can also serve as a base frame for the light grid 40. The beam-forming elements 12a to 12j can also have further structures, for example connecting webs 44 between the beam-forming elements and, if necessary, further light guides 46 for other tasks. Other components that are present in a light grid, such as status indicators in the form of LEDs, can thus be advantageously realized by the one-piece component together with the support body 14 and the beam-forming element 12. In this way, the light grid 40 can be realized in a cost-effective manner. In particular, assembly work can be significantly reduced.

The cross-section through the beam-forming element 12 shown in FIG. 7D along line C-C′ of FIG. 7C corresponds to the schematic representations of the embodiments of the preceding figures and shows the combination of the features described there in each case. Thus, the receptacle 18 for the beam-forming element 12 is pot-shaped, with the beam-forming element 12 extending more in the y-direction than in the z-direction and thus being as narrow as possible in the z-direction. Furthermore, the side walls of the receptacle 18, on which the contact surface 26 is formed between the support body 14 and the beam-forming element 12, are inclined at an angle to the x-direction, which in turn forms the optical axis 28. The receptacle is therefore slightly funnel-shaped with the advantages described above for FIG. 5, in particular with regard to removing the receptacle from an injection mold (not shown here). Finally, on the side of the base surface 20 of the beam-forming element, an opening 30 is provided as an optical aperture in the receptacle 18. On the opposite side (side of the top surface 22), however, the beam-forming element is free of the support body 14, as can be seen in particular from the perspective view of FIG. 7A.

As already mentioned, the base body 42 for the light grid 40 can be manufactured by two-component injection molding. The method begins with the selection of the first and second materials for the support body 14 and for the beam-forming element 12, or the preparation of a common base material for the first and second materials, for example by coloring the base material. The first material for the beam-forming element 12 is permeable to a defined electromagnetic radiation (in particular the light relevant for the application). The second material for the support body is absorbent to this electromagnetic radiation or is made absorbent to this radiation. Both materials have the same or, within a tolerance range, a similar refractive index in relation to the electromagnetic radiation (n₁≈n₂). This is preferably achieved by using a common base material.

The first material and the second material are then filled into an injection molding machine designed for multi-component injection molding and the injection molding process is started.

Depending on the process, the first material and the second material are injected into an injection mold either simultaneously or one after the other. The injection mold is a negative mold of the base body 42 shown in FIG. 7A to 7D. Depending on the process, the support body 14 can be molded first and then the beam-forming element 12 can be injection-molded onto it. However, it is also conceivable that the plurality of beam-forming elements 12a to 12j, including the connecting webs 44 and the optional light guides 46, are formed first and then this structure is overmolded with the support body material.

In principle, the choice of injection molding process depends only on the desired shape of the base body, as long as the common contact surface 26 in the receptacle 18 is seamless between the beam-forming element 12 and the support body 14, so that the aforementioned optical properties, in particular the absorption of scattered light by the support body 14, can occur.

The base body 42 after injection molding comprises at least the support body 14 and the beam-forming elements 12. For a functional light grid, essentially only the electronics with the optoelectronic elements and external connections and an enclosing housing need to be added. Compared to a conventional light grid, in which separate components are used for the support body and beam-forming elements, the assembly work and the associated production costs can be significantly reduced.

FIG. 8A to 8C show variants of an optical device 10 of the type described above with additional light traps 50a, 50b and 50c respectively inside the support body 14.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The scope of protection of the present invention is determined by the following claims and is not limited by the features explained in the description or illustrated in the figures.

1. An optical device comprising:
a beam-forming element made of a first material with a base surface and a top surface, which are opposite one another, and with a surrounding lateral surface, which connects the base surface and the top surface to one another;
a support body made of a second material, which is formed with a receptacle for the beam-forming element and has at least one common contact surface with the lateral surface of the beam-forming element,
wherein the first material and the second material are in direct contact with each other at the contact surface between the beam-forming element and the support body,
wherein the first material is permeable to a defined electromagnetic radiation and the second material is absorbent to the defined electromagnetic radiation,
wherein the first material and the second material each have a defined refractive index (n₁, n₂) in relation to the defined electromagnetic radiation, and
wherein the defined refractive index (n₂) of the second material is set in a defined ratio n₁/n₂ to the defined refractive index (n₁) of the first material in order to set a specific transition characteristic for the defined electromagnetic radiation at the contact surface.

2. The optical device of claim 1 wherein the defined ratio n₁/n₂ is between 0.9 and 1.1.

3. The optical device of claim 1 wherein the defined ratio n₁/n₂ is 1.

4. The optical device of claim 1 wherein the specific transition characteristic causes the contact surface to be low-reflection and low-refraction for the defined electromagnetic radiation coupled in by the base surface and the top surfaces.

5. The optical device of claim 4 wherein the specific transition characteristic causes the contact surface to be reflection-free and refraction-free.

6. The optical device of claim 1 wherein the specific transition characteristic causes the defined electromagnetic radiation coupled in by the base surface and the top surface in a defined angle of incidence range to be absorbed from the contact surface by the second material.

7. The optical device of claim 1 wherein:
the first material is a first transparent plastic, and
the second material is a second colored plastic that absorbs the defined electromagnetic radiation.

8. The optical device of claim 7 wherein the second material is a black plastic.

9. The optical device of claim 7 wherein the first transparent plastic and the second colored plastic each include at least one of polycarbonate, polymethyl methacrylate (PMMA), cycloolefin copolymers, optical polyesters, and polysulfones.

10. The optical device of claim 1 wherein the beam-forming element and the support body are an integrally joined component.

11. The optical device of claim 1 wherein the receptacle is funnel-shaped and tapered in a direction from the top surface to the base surface.

12. The optical device of claim 1 wherein:
the receptacle encloses at least a part of the base surface with at least one opening for the defined electromagnetic radiation, and
the opening is designed as a diaphragm for an optoelectronic element in the beam path.

13. The optical device of claim 12 wherein the opening is filled with the first material of the beam-forming element.

14. The optical device of claim 1 wherein the receptacle forms a tube protruding from the top surface.

15. The optical device of claim 1 wherein protruding structures are formed in the receptacle and act as light traps.

16. The optical device of claim 1 further comprising a plurality of beam-forming elements, each of which has its own receptacle formed in the support body.

17. The optical device of claim 1 wherein the optical device is at least one of a safety light barrier and a safety laser scanner.

18. A manufacturing method for an optical device having a beam-forming element and a support body, the manufacturing method comprising:
providing a first material for the beam-forming element which is permeable to a defined electromagnetic radiation and has a first defined refractive index (n₁) in relation to the defined electromagnetic radiation;
providing a second material for the support body which is absorbent for the defined electromagnetic radiation and has a second defined refractive index (n₂) in relation to the defined electromagnetic radiation;
forming the beam-forming element from the first material and the support body from the second material; and
joining the beam-forming element and the support body to form an integrally joined component made of the first material and the second material,
wherein the beam-forming element has a base surface and a top surface, which lie opposite one another, and a surrounding lateral surface, which connects the base surface and the top surface to one another,
wherein the support body is formed with a receptacle for the beam-forming element and has at least one common contact surface with the surrounding lateral surface of the beam-forming element, and
wherein the second defined refractive index (n₂) of the second material is set in a defined ratio to the first defined refractive index (n₁) of the first material in order to set a specific transition characteristic for the defined electromagnetic radiation at the contact surface.

19. The manufacturing method of claim 18 wherein the manufacturing and assembling involves injection molding.

20. The manufacturing method of claim 19 wherein the injection molding is a multi-component injection molding.
